(19) United States
(12) Patent Application Publication
(10) Pub. No.: US 2026/0342002 A1
(43) Pub. Date: Oct. 29, 2026

(54) CONNECTOR UNIT

(71) Applicant: Yazaki Corporation, Tokyo (JP)

(72) Inventors: Masayoshi Takayanagi, Shizuoka (JP); Sadaharu Okuda, Shizuoka (JP); Hikaru Sano, Shizuoka (JP); Koki Adachi, Shizuoka (JP); Ryoichi Murata, Shizuoka (JP); Takaaki Yuasa, Shizuoka (JP)

(21) Appl. No.: 19/533,476

(22) Filed: Feb. 9, 2026

(30) Foreign Application Priority Data
Feb. 10, 2025 (JP) 2025-019829

(51) Int. Cl. H01R 13/52; H01R 12/77

(52) U.S. Cl. CPC H01R 13/5205; H01R 12/771

(57) ABSTRACT

A connector unit includes a connector, a substrate to which the connector is fixed and which has a terminal connection portion exposed from a housing toward the outside, and a waterproof body provided on one side in a drawing-out direction with respect to the terminal connection portion, and formed extending in a width direction. The waterproof body has a body back surface (sealing surface) that extends in the width direction, adheres closely to the surface of the board body, and seals between the board body, and a first drainage surface (inclined surface) that inclines toward the housing side from the central portion in the width direction toward both ends in the width direction.

### CROSS-REFERENCE TO RELATED APPLICATION(S)

The present application claims priority to and incorporates by reference the entire contents of Japanese Patent Application No. 2025-019829 filed in Japan on Feb. 10, 2025.

### BACKGROUND OF THE INVENTION

### 1. Field of the Invention

The present invention relates to a connector unit.

### 2. Description of the Related Art

Conventionally, when connecting a connector from a direction perpendicular to the surface of a Flexible Printed Circuit (FPC), in order to connect the wiring pattern of the FPC and the connector terminals, a notch or the like is formed in the wall portion of the housing so that a part of the connector terminal is exposed to the outside in a state where the connector terminal is housed in the housing.

Japanese Patent Application Laid-open No. JP 2019 - 192 336 A discloses a wiring module including a flat electric wire and a wire-side connector that is connected to an end portion of the flat electric wire and is fitted to a device-side connector.

Incidentally, in a connector unit combining a connector and an FPC, when water droplets due to dew condensation or the like occur in the surplus length portion of the FPC, depending on the orientation of the connector and the arrangement of the FPC, there is room for improvement because there is a possibility that the water droplets may flow into the connection portion between the wiring pattern of the FPC and the connector terminal.

### SUMMARY OF THE INVENTION

An object of the present invention is to provide a connector unit that prevents water droplets generated by dew condensation or the like from flowing into the terminal connection portion.

In order to achieve the above mentioned object, a connector unit according to one aspect of the present invention includes a connector having a conductive terminal, and an insulating housing that houses and holds the terminal and is formed to be fittable in a fitting direction with respect to a fitting object; a substrate having a board body to which the connector is fixed and which is drawn out from the connector toward one side in a drawing-out direction intersecting the fitting direction, a conductive wiring pattern formed on the board body, and a terminal connection portion that electrically connects the terminal held in the housing and the wiring pattern exposed from a surface of the board body, and is exposed from the housing toward the outside; and a waterproof body provided on the one side in the drawing-out direction with respect to the terminal connection portion, and formed extending in a width direction perpendicular to the fitting direction and the drawing-out direction, wherein the waterproof body has: a sealing surface that extends in the width direction, adheres closely to the surface of the board body, and seals between the board body; and an inclined surface that inclines toward the housing side from a central portion in the width direction toward both ends in the width direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a schematic configuration of a connector unit according to an embodiment;

FIG. 2 is a front view of the connector unit according

to the embodiment as viewed from the fitting direction;

FIG. 3 is a side view of the connector unit according to the embodiment as viewed from the width direction; and

FIG. 4 is a plan view of the connector unit according to the embodiment as viewed from the drawing-out direction.

### DETAILED DESCRIPTION OF THE PREFERRED EMBODIMENTS

Hereinafter, embodiments according to the present invention will be described in detail with reference to the drawings. The present invention is not limited by the following embodiments. That is, the constituent elements in the following embodiments include those that can be easily assumed by a person skilled in the art or those that are substantially the same, and various omissions, substitutions, and modifications can be made without departing from the gist of the invention.

### Embodiment

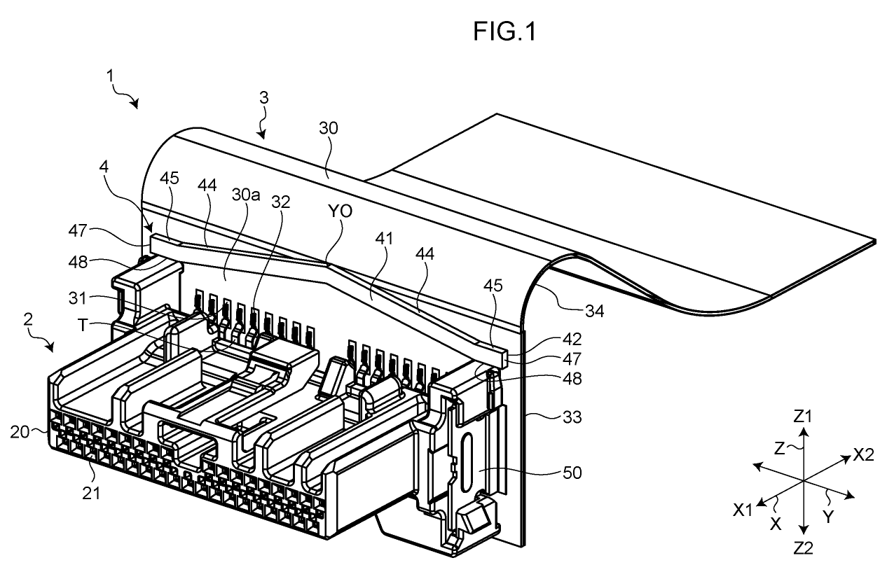

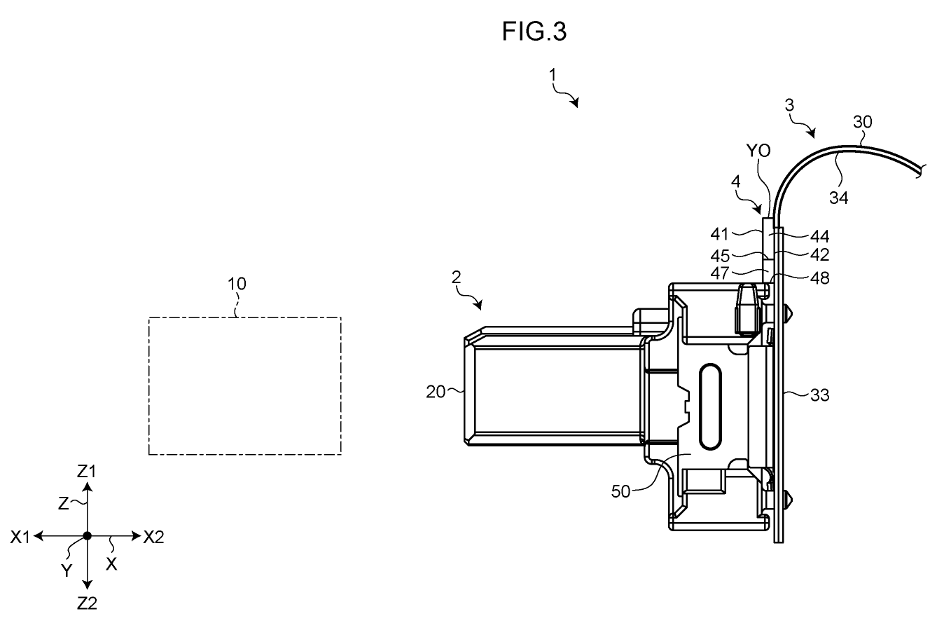

The connector unit 1 illustrated in FIGS. 1, 2, 3, and 4, is applied to, for example, electronic equipment mounted on a vehicle such as an automobile. The connector unit 1 includes a connector 2, a substrate 3, and a waterproof body 4. The connector unit 1 has, for example, a connector 2 mounted on a surface 30a of the substrate 3, and the connector 2 electrically connects a fitting object 10 (see FIG. 3) and the substrate 3 by fitting with the fitting object 10 provided in various devices. The substrate 3 constitutes, for example, an electronic circuit board on which various electronic components (not illustrated) including the connector 2 are mounted on a surface 30a as a mounting surface. Hereinafter, the connector unit 1 will be described in detail.

In the following description, the X direction in the drawing is defined as "insertion/extraction direction X", the Y direction as "width direction Y", and the Z direction as "drawing-out direction Z". The insertion/extraction direction X, the width direction Y, and the drawing-out direction Z are mutually perpendicular. Here, in the insertion/extraction direction X, one side is defined as "fitting direction X1" and the other side as "extraction direction X2". In the drawing-out direction Z, one side is defined as "first drawing-out direction Z1" and the other side as "second drawing-out direction Z2". The width direction Y and the drawing-out direction Z are included in directions perpendicular to the insertion/extraction direction X. Moreover, unless otherwise specified, each direction used in the following description represents a direction in a fitted state in which the respective parts are assembled to each other and the connector 2 of the connector unit 1 is fitted to the fitting object 10. Furthermore, in the above-mentioned fitted state, the drawing-out direction Z is along the vertical direction. In this case, the "first drawing-out direction Z1" is "vertically upper side" and the "second drawing-out direction Z2" is "vertically lower side".

First, the connector 2 will be described. The connector 2 is a board-mounted type connector mounted on a surface 20a of the substrate 3. The connector 2 constitutes, for example, a connection mechanism that electrically connects the substrate 3 and the fitting object 10 by fitting with the fitting object 10 provided in various devices. The connector 2 includes a terminal T and a housing 20.

The terminal T is a terminal fitting formed of a conductive metal material or the like and electrically connects the substrate 3 and the fitting object 10. The terminal T is formed extending in a substantially rod shape along the insertion/extraction direction X, one end is connected to a terminal connection portion 32 in a wiring pattern 31 formed on the substrate 3 by soldering or the like, and the other end is connected to a mating terminal (not illustrated) held by the fitting object 10. In a fitted state in which the connector 2 is fitted to the fitting object 10, the terminals T are arranged in plurality at intervals along the width direction Y and the drawing-out direction Z respectively, and are housed and held in the housing 20. Here, in the fitted state, the terminals T are arranged in two rows along the drawing-out direction Z and are arranged in a larger number along the width direction Y.

The housing 20 is formed of an insulating material such as synthetic resin, holds the terminals T inside an insertion hole 21 (see FIG. 1, etc.), and is fitted with the fitting object 10. The housing 20 is fixed to the substrate 3, for example, via a pair of pegs (fixing fittings) 50 (see FIGS. 1 to 3) provided on the substrate 3. In the fitted state in which the connector 2 is fitted to the fitting object 10, the housing 20 holds the terminals T in plurality arranged at intervals along the width direction Y and the drawing-out direction Z respectively. Here, in the fitted state, the housing 20 holds the plurality of terminals T arranged in two rows along the drawing-out direction Z and in a larger number along the width direction Y. In the housing 20 of the present embodiment, both sides in the drawing-out direction Z perpendicular to the insertion/extraction direction X are not closed and are relatively open toward the outside compared to both sides in the width direction Y of the housing 20. That is, the housing 20 has a shape that enables connection of each terminal T and the wiring pattern 31 by soldering or the like in a state where the housing 20 holds the plurality of terminals T.

Next, the substrate 3 will be described. The substrate 3 is constituted, for example, by a flexible printed circuit (FPC) having flexibility. The substrate 3 is formed in a substantially rectangular shape as a whole. The substrate 3 includes a board body 30, a wiring pattern 31, and a terminal connection portion 32.

The board body 30 is constituted, for example, by laminating a thin film-like insulating base film having flexibility, a conductor layer, an insulating film, and the like, and a wiring pattern 31 corresponding to various functions is formed by the conductor layer. The connector 2 is fixed to a surface 30a of the board body 30, and the board body 30 is drawn out from the connector 2 to one side (first drawing-out direction Z1) in the drawing-out direction Z. The board body 30 includes a fixed portion 33 and a curved portion 34.

The fixed portion 33 is a portion in the board body 30 where an end portion of the housing 20 on the opposite side (extraction direction X2) to the fitting direction X1 is fixed. The fixed portion 33 is positioned on the second drawing-out direction Z2 side of the board body 30. In the fixed portion 33, the plate thickness direction is along the insertion/extraction direction X, and the fixed portion extends in a plate shape along the width direction Y and the drawing-out direction Z.

The curved portion 34 is a portion in the board body 30 that is formed continuously to the fixed portion 33, and in the fitted state in which the connector 2 is fitted to the fitting object 10, is arranged in a curved manner so that a shape viewed from the width direction Y bulges toward one side (first drawing-out direction Z1) in the drawing-out direction Z. In the example illustrated in FIG. 1, the curved portion 34 has a degree of curvature that changes toward the extraction direction X2 side.

The wiring pattern 31 is a conductive printed circuit body formed on the board body 30. The wiring pattern 31 is formed of thin copper foil or the like and constitutes circuits corresponding to various functions. For example, a thin film-like insulating film is laminated on the wiring pattern 31, and portions corresponding to the terminal connection portion 32 are exposed to the outside.

The terminal connection portion 32 is a portion that electrically connects the terminal T held in the housing 20 and the wiring pattern 31 exposed from the surface 30a of the board body 30, and is exposed from the housing 20 toward the outside. Similarly to the terminal T, in the fitted state in which the connector 2 is fitted to the fitting object 10, the terminal connection portions 32 are arranged in plurality at intervals along the width direction Y and the drawing-out direction Z respectively. Here, in the fitted state, the terminal connection portions 32 are arranged in two rows along the drawing-out direction Z and are arranged in a larger number along the width direction Y. The terminal connection portion 32 is constituted by connecting an end portion on one side (extraction direction X2) in the extending direction (insertion/extraction direction X) of the terminal T to a part of the wiring pattern 31 exposed to the outside from the insulating film.

Next, the waterproof body 4 will be described. The waterproof body 4 is provided on one side Z1 in the drawing-out direction Z with respect to the terminal connection portion 32, and is formed extending in the width direction Y. When the drawing-out direction Z is along the vertical direction, the waterproof body 4 is positioned on the vertically upper side of the terminal connection portion 32 in the fitted state in which the connector 2 is fitted to the fitting object 10. The waterproof body 4 has a body front surface 41, a body back surface 42, a first drainage surface 44, a second drainage surface 45, a pair of end surfaces 47, and a pair of positioning surfaces 48.

The body front surface 41 is a surface positioned on the front side at the time when the body back surface 42 is bonded to the board body 30. In the fitted state, the body front surface 41 is positioned on the fitting direction X1 side, and a shape viewed from the fitting direction X1 is formed in a substantially inverted V-shape.

The body back surface 42 is a sealing surface that extends in the width direction Y in a state of being fixed to the substrate 3, adheres closely to the surface 30a of the board body 30, and seals the space between the board body 30 and itself. In the fitted state, the body back surface 42 is positioned on the extraction direction X2 side, and similarly to the body front surface 41, is formed in a substantially inverted V-shape.

The first drainage surface 44 is an inclined surface that inclines toward the housing 20 side from a central portion YO in the width direction Y toward both ends in the width direction Y respectively. In the fitted state, each of the first drainage surfaces 44 is positioned on one side (first drawing-out direction Z1) in the drawing-out direction Z.

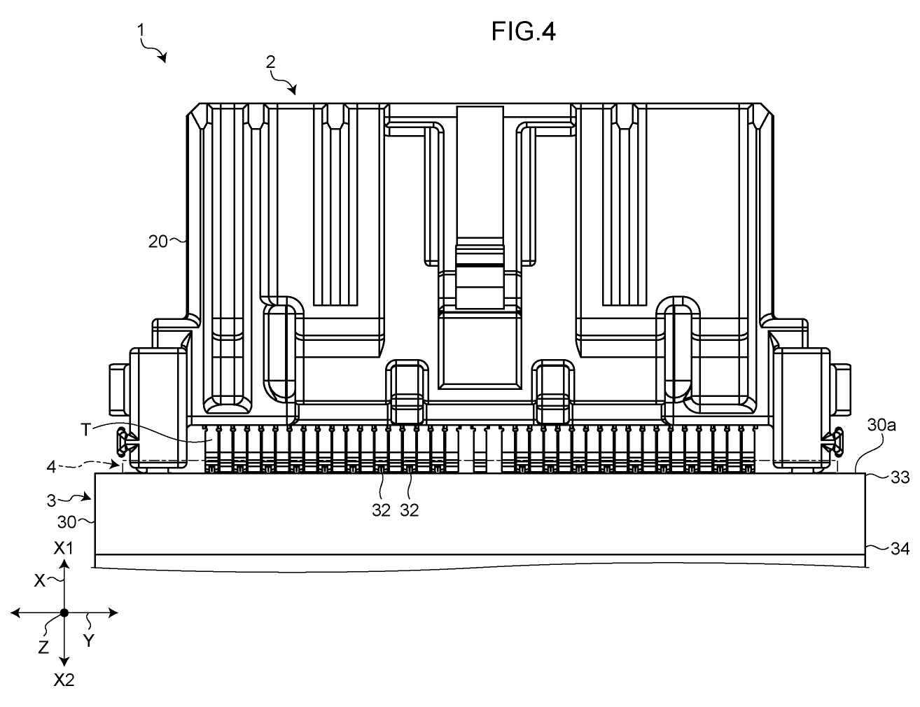

Each of the second drainage surfaces 45 is continuous with the first drainage surface 44 at one side or the other side in the width direction Y, and is connected to the end surface 47 at the other side or the one side. The second drainage surface 45 has an inclination angle that is relatively smaller than that of the first drainage surface 44. Here, the second drainage surface 45 is formed perpendicular to the end surface 47, and is constituted by a surface that does not incline in either case. The first drainage surface 44 and the second drainage surface 45 have the same width in the insertion/extraction direction X in the fitted state. That is, it is assumed that the plate thickness direction of the waterproof body 4 is along the insertion/extraction direction X, and its thickness is uniform. As illustrated in FIG. 4, the thickness of the waterproof body 4 is formed so as to hide all the terminal connection portions 32 when viewed from the first drawing-out direction Z1 in a state where the waterproof body 4 is bonded to the board body 30.

The positioning surface 48 is a surface on the opposite side of the second drainage surface 45, and is a surface that abuts against a flat surface formed at an end portion on the first drawing-out direction Z1 side of the housing 20 in a state where the waterproof body 4 is bonded to the board body 30.

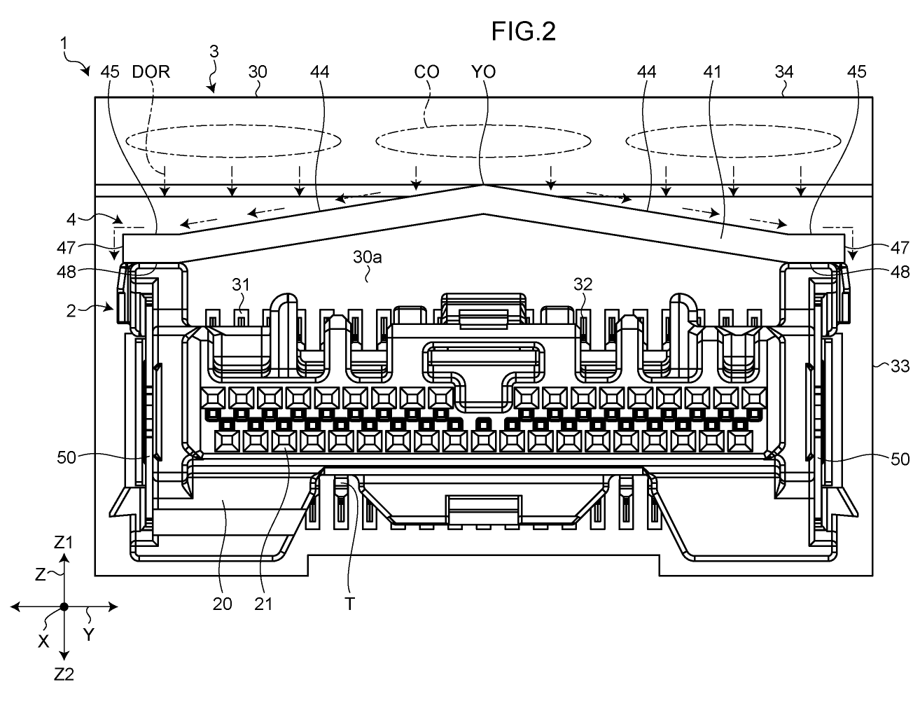

In a conventional connector unit, as illustrated in FIG. 2, when dew condensation CO occurs on the substrate 3 positioned on the vertically upper side of the terminal connection portion 32, there is a possibility that water droplets DOR from the dew condensation CO may flow into the terminal connection portion 32 side.

Therefore, in the connector unit 1 of the present embodiment, in the fitted state, the waterproof body 4 is positioned on the vertically upper side of the terminal connection portion 32, the body back surface 42 adheres closely to the board body 30, and the first drainage surface 44 inclines toward the housing 20 side from the central portion YO in the width direction Y toward both ends in the width direction Y respectively, thereby preventing water droplets DOR generated from dew condensation CO from flowing into the terminal connection portion 32 side. That is, the connector unit 1 prevents water droplets DOR generated from dew condensation CO from directly flowing into the terminal connection portion 32 by the body back surface 42 of the waterproof body 4 being bonded to and sealing the surface 30a of the fixed portion 33 in the board body 30. Moreover, the connector unit 1 inclines from the central portion YO in the width direction Y toward both ends in the width direction Y respectively by the inclined first drainage surface 44, so it becomes possible to easily drain water droplets DOR generated from dew condensation CO toward the outside of the housing 20. Moreover, the positioning surface 48 suppresses the flowing-in of water droplets DOR heading toward the terminal connection portion 32 from the width direction Y by abutting against the housing 20.

As described above, the connector unit 1 according to the present embodiment includes the waterproof body 4 provided on the first drawing-out direction Z1 side with respect to the terminal connection portion 32 that electrically connects the terminal T held in the housing 20 and the wiring pattern 31 exposed from the surface 30a of the board body 30. The waterproof body 4 has a body back surface (sealing surface) 42 that extends in the width direction Y, adheres closely to the surface 30a of the board body 30, and seals between the board body 30, and a first drainage surface (inclined surface) 44 that inclines toward the housing 20 side from the central portion YO in the width direction Y toward both ends in the width direction Y.

With the above configuration, even if water droplets DOR from dew condensation CO or the like generated on the surface 30a of the curved portion 34 in the board body 30 attempt to flow into the terminal connection portion 32 side, the connector unit 1 can prevent the flowing-in of water droplets DOR by the first drainage surface 44, and can drain the water droplets DOR to the outside in the width direction Y by the inclination of the first drainage surface 44. As a result, the connector unit 1 can prevent water droplets DOR generated by dew condensation CO or the like from flowing into the terminal connection portion 32.

Moreover, in the connector unit 1, the waterproof body 4 is positioned on the vertically upper side of the terminal connection portion 32 in the fitted state. Thereby, the connector unit 1 can prevent water droplets DOR generated from dew condensation CO or the like from flowing into the terminal connection portion 32 side positioned on the vertically lower side by the waterproof body 4.

Moreover, in the connector unit 1, since the board body 30 has the fixed portion 33 to which the housing 20 is fixed, the fixing of the housing 20 to the board body 30 can be facilitated. Moreover, in the connector unit 1, the board body 30 includes a curved portion 34 that is formed continuously to the fixed portion 33 and, in the fitted state, is arranged in a curved manner so that a shape viewed from the width direction Y bulges toward the first drawing-out direction Z1 side. Thereby, in the connector unit 1, the curved portion 34 becomes deflection of the board body 30, and the fitting operation of the connector 2 with respect to the fitting object 10 can be facilitated.

In the above embodiment, in the connector unit 1, the waterproof body 4 and the housing 20 are formed separately, but the present invention is not limited thereto, and the waterproof body 4 and the housing 20 may be integrally formed. Thereby, for example, compared to the component management cost when the waterproof body 4 and the housing 20 are managed as separate bodies, the component management cost of the housing 20 integrated with the waterproof body 4 can be made relatively inexpensive.

Moreover, in the above embodiment, the connector unit 1 has been described with the substrate 3 having flexibility as a whole, but the present invention is not limited thereto. In this case, in the substrate 3, only the curved portion 34 may have flexibility.

Moreover, in the above embodiment, in the waterproof body 4, the first drainage surface 44 and the second drainage surface 45 are formed with mutually different inclination angles, but the present invention is not limited thereto. For example, the first drainage surface 44 and the second drainage surface 45 may be uniformly formed with the same inclination angle.

According to the connector unit of the present embodiment, for example, there is an effect of preventing water droplets generated by dew condensation or the like on the substrate positioned on the vertically upper side of the terminal connection portion from flowing into the terminal connection portion.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A connector unit comprising:
a connector having a conductive terminal, and an insulating housing that houses and holds the terminal and is formed to be fittable in a fitting direction with respect to a fitting object;
a substrate having a board body to which the connector is fixed and which is drawn out from the connector toward one side in a drawing-out direction intersecting the fitting direction, a conductive wiring pattern formed on the board body, and a terminal connection portion that electrically connects the terminal held in the housing and the wiring pattern exposed from a surface of the board body, and is exposed from the housing toward the outside; and
a waterproof body provided on the one side in the drawing-out direction with respect to the terminal connection portion, and formed extending in a width direction perpendicular to the fitting direction and the drawing-out direction, wherein
the waterproof body has:
a sealing surface that extends in the width direction, adheres closely to the surface of the board body, and seals between the board body; and
an inclined surface that inclines toward the housing side from a central portion in the width direction toward both ends in the width direction.

2. The connector unit according to claim 1, wherein
the drawing-out direction is along a vertical direction in a fitted state in which the connector is fitted to the fitting object, and
the waterproof body is positioned on a vertically upper side of the terminal connection portion in the fitted state.

3. The connector unit according to claim 1, wherein
the waterproof body is formed integrally with the housing.

4. The connector unit according to claim 2, wherein
the waterproof body is formed integrally with the housing.

5. The connector unit according to claim 1, wherein
the board body includes:
a fixed portion to which an end portion of the housing on an opposite side to the fitting direction is fixed; and
a curved portion that is formed continuously to the fixed portion, and in a fitted state in which the connector is fitted to the fitting object, is arranged in a curved manner so that a shape viewed from the width direction bulges toward the one side in the drawing-out direction.

6. The connector unit according to claim 2, wherein
the board body includes:
a fixed portion to which an end portion of the housing on an opposite side to the fitting direction is fixed; and
a curved portion that is formed continuously to the fixed portion, and in a fitted state in which the connector is fitted to the fitting object, is arranged in a curved manner so that a shape viewed from the width direction bulges toward the one side in the drawing-out direction.
